(19) United States
(12) Patent Application Publication
(10) Pub. No.: US 2013/0094869 A1
(43) Pub. Date: Apr. 18, 2013

(54) FUSING UNIT OF IMAGE FORMING APPARATUS AND CONTROL METHOD FOR THE SAME

(71) Applicant: SAMSUNG ELECTRONICS CO., LTD., Suwon-si (KR)

(72) Inventors: Jin-Seok LEE, Anyang (KR); Dong Woo Lee, Seoul (KR)

(73) Assignee: SAMSUNG ELECTRONICS CO., LTD., Suwon-si (KR)

(21) Appl. No.: 13/653,786

(22) Filed: Oct. 17, 2012

(30) Foreign Application Priority Data
Oct. 17, 2011 (KR) 10-2011-0106061

(51) Int. Cl. G03G 15/20

(52) U.S. Cl. 399/33

(57) ABSTRACT

A fusing unit and an image forming apparatus including the same, and method are provided. The fusing unit senses an error such as local overheating in a surface heater, which uniformly emits heat throughout the surface of a belt member. The fusing unit includes a heating member with a pattern to heat a recording medium, a power supply to supply power to the heating member, a pressing member to transmit rotational force to the heating member while in contact with the heating member and to apply pressure to the recording medium, a driver to rotatably drive the pressing member, a pattern sensor to sense the pattern, and a controller to determine whether there is an error in the rotation of the heating member, based on an output from the pattern sensor.

### CROSS-REFERENCE TO RELATED APPLICATION(S)

This application is related to and claims priority to Korean Patent Application No. 10-2011-106061, filed on Oct. 17, 2011 in the Korean Intellectual Property Office, the disclosure of which is incorporated herein by reference.

### BACKGROUND

1. Field

Embodiments discussed herein relate to a fusing unit of an image forming apparatus, which is capable of sensing whether there is slippage generated in a member.

2. Description of the Related Art

An electrophotographic image forming apparatus is an appliance for printing an image by scanning, with light, a photosensitive body charged with a certain voltage, to form an electrostatic latent image, developing the electrostatic latent image by toners of certain colors, and transferring and fusing the developed image to a printing medium. Such an electrophotographic image forming apparatus includes a fusing unit installed in a printing path, to fuse an image transferred to a printing medium.

The fusing unit includes a heating member to apply heat to a printing sheet, and a pressing member to apply pressure to the printing member. When an abnormal situation such as jamming occurs during printing, the pressing member may not rotate or slippage may be generated between the heating member and the pressing member. Local heating by a heat source may occur, so that the heating member may be degraded or damaged.

In conventional apparatus, temperature sensors are installed at a portion of the outer circumferential surface of the heating member, which is pressed by the pressing member, and a portion of the outer circumferential surface, which is not pressed by the pressing member, respectively, in order to sense an error. When the difference between the temperatures sensed by the temperature sensors exceeds a threshold value, it is determined that an error such as slippage has been generated.

Recently, a technology of applying a surface heater such as a carbon nanotube (CNT) belt exhibiting excellent heating performance to the heating member has been developed. The heating member may include a surface heater, such that heat is uniformly emitted throughout the surface of the heating member. Thus, it may be impossible for a conventional unit to sense an error caused by a difference in surface temperature occurring at the heating member.

### SUMMARY

According an aspect of the exemplary embodiment of the present invention, a fusing unit is provided capable of sensing an error such as local overheating in a surface heater that uniformly emit heat throughout the surface of a belt member.

Additional aspects and/or advantages will be set forth in part in the description which follows and, in part, will be apparent from the description, or may be learned by practice of the invention.

In accordance with an aspect of the present invention, a fusing unit of an image forming apparatus to form an image on a recording medium in an electrophotographic manner, includes a heating member to heat the recording medium, the heating member being formed, at a surface thereof, with a predetermined pattern, a power supply to supply power to the heating member, a pressing member to transmit rotational force to the heating member while in contact with the heating member and to apply pressure to the recording medium, a driver to rotatably drive the pressing member, a pattern sensor to sense the pattern formed at the heating member and to output a result of the sensing in the form of a signal, and a controller to determine whether there is an error in the rotation of the heating member, based on the output from the pattern sensor.

The heating member may include a belt member including a surface heater, a support member to rotatably support the belt member, and a fusing nip member disposed at a region where the belt member receives pressure from the pressing member, to form a fusing nip.

The belt member may include a carbon nanotube (CNT) belt.

The fusing unit may include metal members respectively joined to opposite ends of the surface heater, to supply power to the surface heater. The pattern may be formed at a surface of one of the metal members.

The pattern sensor may include one selected from a group consisting of a reflection sensor, a photo sensor and a velocity sensor.

The controller may include a velocity calculator to calculate a linear velocity of the pattern, based on the output from the pattern sensor, and an error discriminator to determine that there is an error in the rotation of the heating member when the linear velocity of the pattern calculated by the velocity calculator is less than a predetermined reference value.

The controller may include a power shut-off unit to shut off power supplied from the power supply to the heating member when the error discriminator determines that there is an error.

In accordance with an aspect of the present invention, a fusing unit of an image forming apparatus to form an image on a recording medium in an electrophotographic manner, includes a heating member including a surface heater to heat the recording medium, a power supply to supply power to the heating member, a pressing member to transmit rotational force to the heating member while in contact with the heating member and to apply pressure to the recording medium, a driver to rotatably drive the pressing member, a first sensor mounted in the heating member, to measure an internal temperature of the heating member, a second sensor mounted to an outside of the heating member, to measure a surface temperature of the heating member, and a controller to determine whether there is an error in the rotation of the heating member, based on outputs from the first and second sensors.

The controller may include an error discriminator to determine that there is an error in the rotation of the heating member when a difference between the temperature measured by the first sensor and the temperature measured by the second sensor is not less than a predetermined reference value.

The controller may include a power shut-off unit to shut off power supplied from the power supply to the heating member when the error discriminator determines that there is an error.

The heating member may include a belt member including the surface heater, a support member to rotatably support the belt member, and a fusing nip member disposed at a region where the belt member receives pressure from the pressing member, to form a fusing nip.

The first sensor may be mounted to the fusing nip member, to measure a temperature of the fusing nip.

In accordance with an aspect of the present invention, an image forming apparatus includes a photosensitive body, an exposure unit to form an electrostatic latent image on the photosensitive body, a developing unit to develop the latent image, for formation of a toner image, a transfer unit to transfer the toner image formed by the developing unit to a recording medium, and a fusing unit to fuse the toner image transferred to the recording medium, wherein the fusing unit includes a heating member to heat the recording medium, the heating member being formed, at a surface thereof, with a predetermined pattern, a power supply to supply power to the heating member, a pressing member to transmit rotational force to the heating member while in contact with the heating member and to apply pressure to the recording medium, a driver to rotatably drive the pressing member, a pattern sensor to sense the pattern formed at the heating member and to output a result of the sensing in the form of a signal, and a controller to determine whether there is an error in the rotation of the heating member, based on the output from the pattern sensor.

The heating member may include a belt member including a surface heater, a support member to rotatably support the belt member, and a fusing nip member disposed at a region where the belt member receives pressure from the pressing member while contacting the pressing member, to form a fusing nip.

The controller may include a velocity calculator to calculate a linear velocity of the pattern, based on the output from the pattern sensor, and an error discriminator to determine that there is an error in the rotation of the heating member when the linear velocity of the pattern calculated by the velocity calculator is less than a predetermined reference value.

The controller may include a power shut-off unit to shut off power supplied from the power supply to the heating member when the error discriminator determines that there is an error.

In accordance with an aspect of the present invention, an image forming apparatus includes a photosensitive body, an exposure unit to form an electrostatic latent image on the photosensitive body, a developing unit to develop the latent image, for formation of a toner image, a transfer unit to transfer the toner image formed by the developing unit to a recording medium, and a fusing unit to fuse the toner image transferred to the recording medium, wherein the fusing unit includes a heating member to heat the recording medium while rotating, a power supply to supply power to the heating member, a pressing member to transmit rotational force to the heating member while in contact with the heating member and to apply pressure to the recording medium, a driver to rotatably drive the pressing member, a first sensor mounted in the heating member, to measure an internal temperature of the heating member, a second sensor mounted to an outside of the heating member, to measure a surface temperature of the heating member, and a controller to determine whether there is an error in the rotation of the heating member, based on outputs from the first and second sensors.

The controller may include an error discriminator to determine that there is an error in the rotation of the heating member when a difference between the temperature measured by the first sensor and the temperature measured by the second sensor is not less than a predetermined reference value.

In accordance with an aspect of the present invention, a control method for a fusing unit of an image forming apparatus to form an image on a recording medium in an electrophotographic manner includes sensing a pattern formed on a surface of a heating member to heat the recording medium, calculating a linear velocity of the pattern, based on a result of the sensing, comparing the calculated linear velocity of the pattern with a predetermined reference value, and determining that there is an error in a rotation of the heating member, when it is determined, based on a result of the comparison, the calculated linear velocity of the pattern is less than a predetermined value.

The heating member may include a belt member including a surface heater, a support member to rotatably support the belt member, and a fusing nip member disposed at a region where the belt member receives pressure from the pressing member, to form a fusing nip.

Metal members may be joined to opposite ends of the surface heater, respectively, to supply power to the surface heater, and the pattern may be formed at a surface of one of the metal members.

The control method may include shutting off power supplied to the heating member when it is determined that there is an error in the rotation of the heating member.

### BRIEF DESCRIPTION OF THE DRAWINGS

Reference will now be made in detail to the embodiments, examples of which are illustrated in the accompanying drawings, wherein like reference numerals refer to the like elements throughout. The embodiments are described below to explain the present invention by referring to the figures of which:

FIG. 1 illustrates an image forming apparatus according to an exemplary embodiment of the present invention;

FIG. 2 illustrates a conventional fusing unit, which includes a heating member including a belt member and a heat source disposed within the belt member;

FIGS. 3A and 3B illustrates a fusing unit according to an exemplary embodiment of the present invention;

FIG. 4 illustrates an exemplary fusing unit viewed toward an outer circumferential surfaces of heating and pressing members of the fusing unit;

FIG. 5 illustrates a fusing unit according to an embodiment of the present invention;

FIGS. 6A and 6B illustrates control configurations of a pattern sensor and a controller according to an exemplary embodiment of the present invention;

FIG. 7 illustrates an outer view of a fusing unit, which includes a pattern according to an embodiment of the present invention;

FIG. 8 illustrates an outer view of the fusing unit, which includes a pattern according to an embodiment of the present invention;

FIG. 9 illustrates a fusing unit according to an embodiment of the present invention;

FIG. 10 illustrates a fusing unit according to the embodiment of FIG. 9 when viewed toward outer circumferential surfaces of the pressing and heating members;

FIG. 11 illustrates the fusing unit according to the embodiment of FIG. 9 when viewed in a circumferential direction;

FIG. 12 illustrates exemplary variations in temperatures measured when the fusing unit according to the embodiment of FIG. 9 operates normally;

FIG. 13 illustrates exemplary variations in temperatures measured when rotation of the belt member is stopped due to slippage generated in the fusing unit according to the embodiment of FIG. 9;

FIG. 14 illustrates a method of determining whether there is an error in the fusing unit of an image forming apparatus, and executing control, based on the result of the determination;

FIG. 15 illustrates linear pattern velocity calculation executed at regular intervals in the fusing unit of the image forming apparatus; and

FIG. 16 illustrates a method of determining whether there is an error in the fusing unit of the image forming apparatus, and executing control, based on the result of the determination.

### DETAILED DESCRIPTION

Exemplary embodiments of the present invention are described with reference to the accompanying drawings.

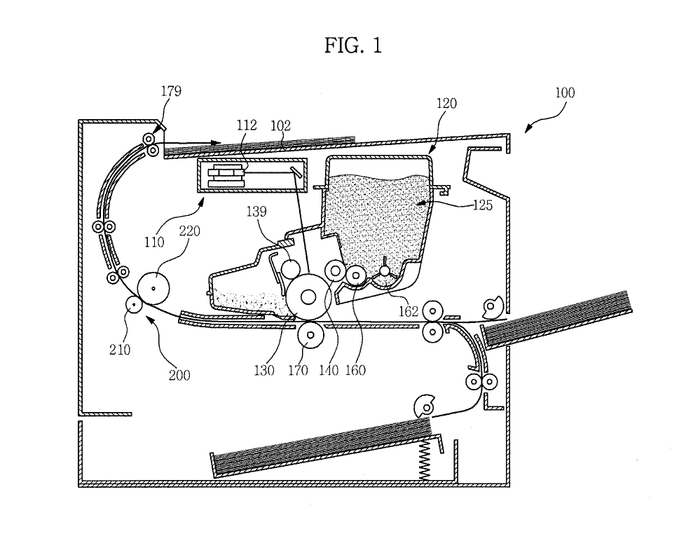

FIG. 1 illustrates an image forming apparatus 100 according to an exemplary embodiment of the present invention.

The image forming apparatus according includes an exposure unit 110 to form an electrostatic latent image on a photosensitive body 130, a developing unit 120 to develop the latent image, and thus to form a toner image, and a transfer unit to transfer the toner image formed by the developing unit 120 to a recording medium. The image forming apparatus includes a fusing unit 200 to fuse the toner image transferred to the recording medium.

The exposure unit 110 scans light corresponding to image information onto the photosensitive body 130, to form an electrostatic latent image on an outer circumferential surface of the photosensitive body 130. The exposure unit 110 includes a light source (not shown) to emit a laser beam, and a beam deflector 112 to deflect the emitted laser beam.

The developing unit 120 may be detachably mounted in a body of the image forming apparatus. The photosensitive body 130 may be included in the developing unit 120. The developing unit 120 includes a developing roller 140 facing the photosensitive body 130, a charging roller 139, a supply roller 10, and a stirrer 162. The photosensitive body 130 may be installed such that a portion of the outer circumferential surface thereof is exposed. The photosensitive body 130 may be rotatable in a predetermined direction. The photosensitive body 130 has a cylindrical drum structure, and includes an optical conductive material layer coated over the outer circumferential surface of the photosensitive body 130 in accordance with a deposition method or the like. The photosensitive body 130 is charged with a certain voltage by the charging roller 139. An electrostatic latent image corresponding to an image to be printed is formed on the outer circumferential surface of the photosensitive body 130 by light emitted from the exposure unit 110.

The developing roller 140 receives a toner, e.g., in the form of a powder. The developing roller 140 supplies the toner to the latent image formed on the photosensitive body 130, to develop the latent image into a toner image. A developing bias voltage is applied to the developing roller 140 in order to supply the toner to the photosensitive body 130. The developing roller 140 comes, at an outer circumferential surface thereof, into contact with the outer circumferential surface of the photosensitive body 130, to form a developing nip. A developing gap is formed when the outer circumferential surface of the developing roller 140 moves away from the outer circumferential surface of the photosensitive body 130. The developing nip or developing gap may be uniformly formed in an axial direction between the developing roller 140 and the photosensitive body 130.

The supply roller 160 supplies the toner to the developing roller 140 such that the toner is attached to the developing roller 140. The stirrer 162 feeds the toner from a toner storage 125 toward the supply roller 160 while stirring the toner in order to prevent the toner from clumping.

The transfer unit includes a transfer roller 170. The transfer roller 170 faces the outer circumferential surface of the photosensitive body 130. A transfer bias voltage having opposite polarity to the toner image developed on the photosensitive body 130 is applied to the transfer roller 170 in order to transfer the toner image to a recording medium P. The toner image is transferred to the recording medium P by electrostatic force and mechanical contact pressure exerting between the photosensitive body 130 and the transfer roller 170.

The fusing unit 200 includes a pressing member 210, which has the form of a roller including a metal core and an elastic layer formed over the metal core, a driver (not shown) to rotate the pressing member 210, and a heating member 220. The fusing unit 200 applies heat and pressure to the toner image transferred to the recording medium P, to fuse the toner image to the recording medium P. The pressing member 210 may be in close contact with the heating member 220 at an outer circumferential surface thereof. When the pressing member 210 is rotated by the driver, the heating member 220 is rotated by rotational force transmitted thereto from the pressing member 210. When the recording medium P, to which the toner image has been transferred, passes through a fusing nip formed between the pressing member 210 and the heating member 220 in accordance with rotations of the pressing member 210 and heating member 220, heat and pressure are applied to the recording medium P such that the toner image is fused to the recording medium P. The recording medium P, to which the toner image has been fused, is discharged outwardly of the image forming apparatus via a discharge roller 179. The discharged recording medium P is stacked on a discharge tray 102.

A configuration of the fusing unit 200 according to an embodiment of the present invention is described in detail.

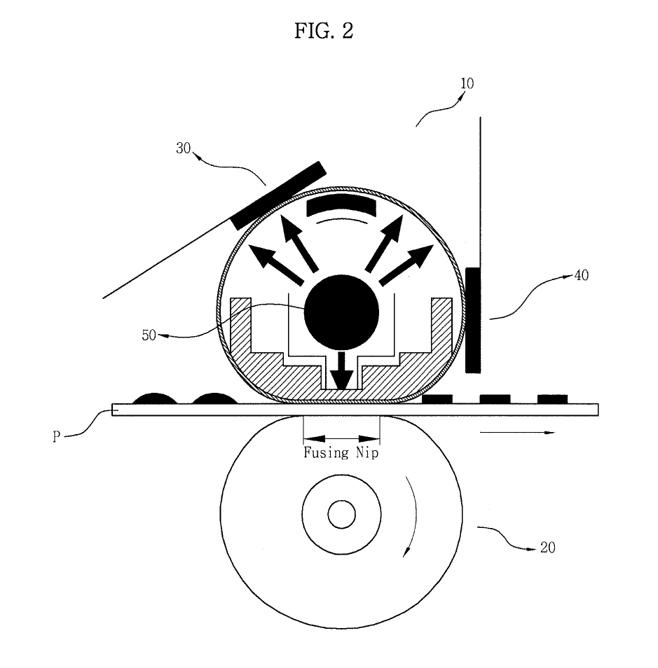

FIG. 2 illustrates a conventional fusing unit, which includes a heating member including a belt member and a heat source disposed within the belt member.

In a conventional belt type heating member, a heat source is disposed within a belt member. In order to determine whether there is an error in rotation of such a heating member, as shown in FIG. 2, temperature sensors 30 and 40 are mounted to the surface of the belt member at a position far from a fusing nip defined between a heating member 10 and a pressing member 20, respectively. It is determined whether the difference between the temperatures sensed by the temperature sensors 30 and 40 is less than a reference value. Such a system is usable in the heating member of FIG. 2 because the heating member is not a surface heater. In this case, it is difficult to mount temperature sensors within the belt member because the heat source is disposed within the belt member.

As mentioned above, a technology of using a belt member constituted by a surface heater exhibiting excellent heating performance has recently been developed. The fusing unit 200 of the image forming apparatus according to the illustrated embodiment of the present invention uses a belt member constituted by a surface heater, in place of a heating roller.

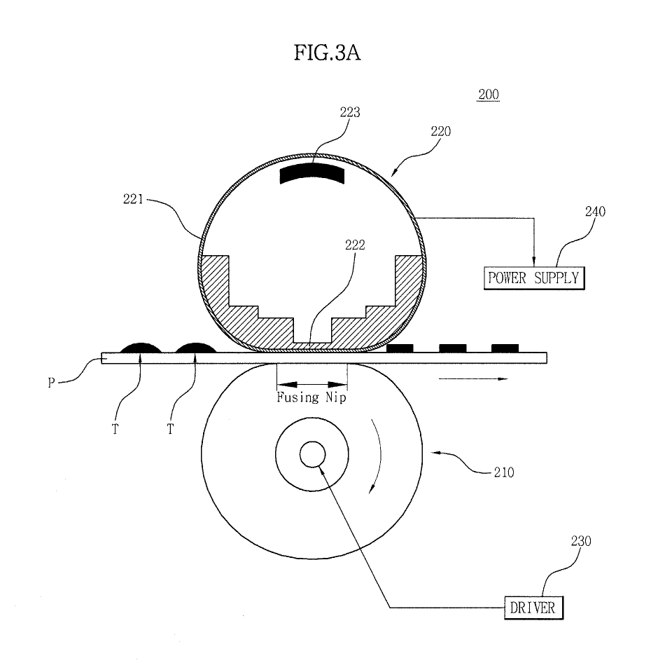

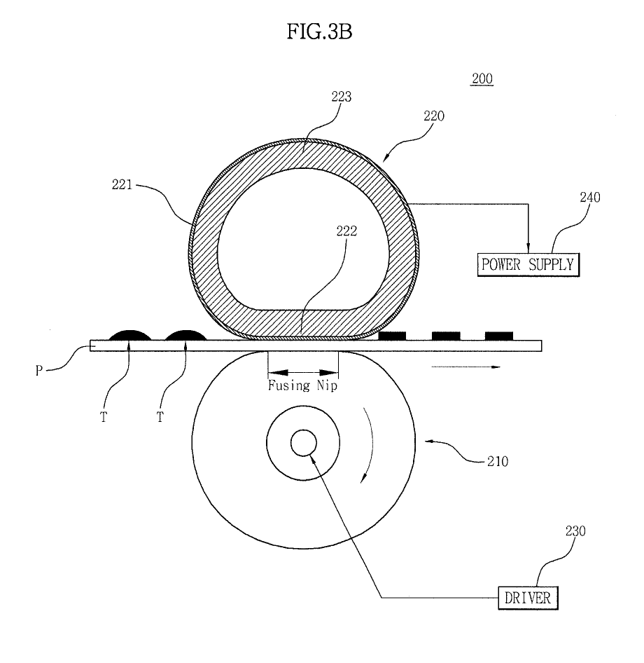

FIGS. 3A and 3B illustrate fusing unit 200 according to an exemplary embodiment of the present invention.

Referring to FIGS. 3A and 3B, a surface of the recording medium P, to which a toner image T has been transferred, contacts the heating member 220 at the fusing nip. An opposite surface of the recording medium P may be supported by the pressing member 210. When the recording medium P passes through the fusing nip in accordance with rotation of the pressing member 210 and heating member 220, heat and pressure are applied to the recording medium P such that the toner image is fused to the recording medium P.

Referring to FIG. 3A, in accordance with an exemplary embodiment of the present invention, the heating member 220 of the fusing unit 200 includes a belt member 221, which includes a surface heater, a support member 223 to rotatably support the belt member 221, and a fusing nip member 222 disposed at a region where the belt member 221 contacts the pressing member 210 and receives pressure from the pressing member 210, to form a fusing nip. The belt member 221 contacts the pressing member 210 at a position corresponding to the fusing nip member 222 and receives rotational force from the pressing member 210 during rotation of the pressing member 210. Thus, the belt member 221 rotates while traveling along outer surfaces of the support member 223 and fusing nip member 222 in a circulating manner.

The support member 223 and fusing nip member 222 may be separated from each and in the circulating travel path of the belt member 221 in as illustrated in FIG. 3A. However, when the belt member 221 has low rigidity, the support member 223 and fusing nip member 222 may be connected to form a roller structure, as illustrated in FIG. 3B, to achieve smoother rotation of the belt member 221. According to an exemplary embodiment of the present invention, the fusing unit 200 has a structure in which the support member 223 and fusing nip member 222 are separated from each other.

An exemplary surface heater is a carbon nanotube (CNT) belt. The CNT is a molecule of carbon atoms that has an elongated cylindrical framework of carbons connected by hexagonal rings while having a diameter of about a nanometer. Such a CNT belt may be formed using a extrusion molding method in which a CNT layer is extruded in a polyimide (PI) belt as a base belt. When such a CNT belt is used as the belt member 221 of the heating member 220, rapid heating may be achieved with low power consumption, and thus reduce a first-page printing time, i.e. the time taken for the image forming apparatus to print a first page.

The CNT belt is an example of a surface heater. There is no limitation as to the kind and manufacturing method of the surface heater other than the surface heater being capable of uniformly emitting heat throughout the surface thereof. For convenience of description, an exemplary embodiments is described in conjunction with a CNT belt is used for the belt member 221.

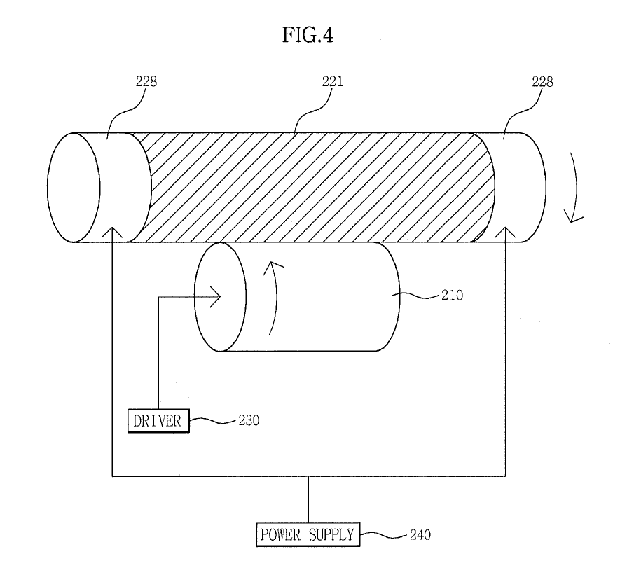

FIG. 4 illustrates a fusing unit 200, which has a configuration according to an exemplary embodiment of the present invention, when viewed toward the outer circumferential surfaces of the heating member 220 and pressing member 210 of the fusing unit 200.

Referring to FIG. 4, metal members 228 may be joined to opposite ends of a CNT belt, namely, the belt member 221, respectively, for supply of power. When power is supplied to the CNT belt via the metal members 228, heat is generated in accordance with a resistance function of the CNT belt. As a result, the temperature of the heating member 220 is increased to a fusing temperature, for example, 150 to 200° C. The toner on the recording medium P is melted by the heat generated from the heating member 220. The melted toner may be pressed onto the surface of the recording medium P by pressure applied to the recording medium P by the heating member 220 and pressing member 210, which contact each other.

A configuration and operation of an exemplary fusing unit of the present invention is described in detail with reference to information as described above.

In the fusing unit of the image forming apparatus according to an illustrated exemplary embodiment of the present invention, a predetermined pattern is formed on the surface of the belt member 221. A sensor may be mounted to sense the pattern. Through calculation of a linear velocity of the pattern, it may be determined whether the heating member 220 rotates normally, e.g., whether there is an error such as slippage in the fusing unit.

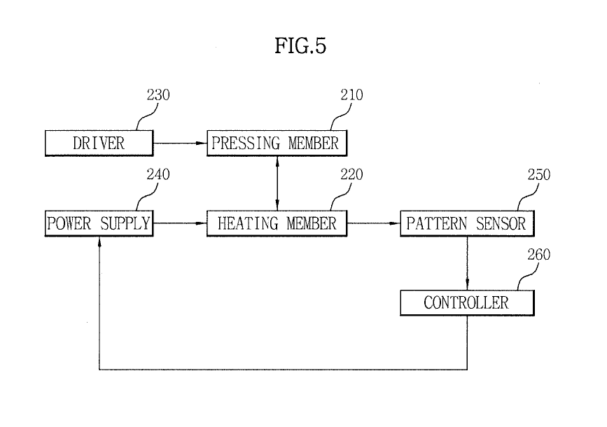

FIG. 5 illustrates a block diagram of a fusing unit according to an exemplary embodiment of the present invention.

Referring to FIG. 5, the fusing unit includes a heating member 220 formed with a predetermined pattern at a surface thereof, a power supply 240 to supply power to the heating member 220, a pressing member 210 contacting the heating member 220 to transmit rotational force to the heating member 220 while applying pressure to a recording medium, and a driver 230 to rotate the pressing member 210. The fusing unit includes a pattern sensor 250 to sense the pattern and to output the sensed result in the form of a signal, and a controller 260 to determine whether an error has been generated, based on the output signal from the pattern sensor 250.

The driver 230 includes a drive motor to generate rotational force, and gears to transmit the rotational force to the pressing member 210. When rotational force is generated from the driver 230, the pressing member 210 is rotated.

The pressing member 210 includes a pressing roller contacting the heating member 220 while rotating, and an elastic biasing unit to bias the pressing roller toward the heating member 220. The pressing roller may be rotated by rotational force received from the driver 230 upon the outer circumferential surface of the pressing roller being in close contact with the outer circumferential surface of the heating member 220 by the elastic biasing unit. In accordance with rotation of the pressing roller, the heating member 220 is rotated. The pressing roller applies pressure to the recording medium, which passes through the fusing nip defined between the pressing member 210 and the heating member 220, while rotating together with the heating member 220.

The heating member 220 may include the belt member 221, which contacts the pressing member 210, to receive rotational force from the pressing member 210. The fusing nip member 222 may be disposed at a region where the belt member 221 and contact the pressing roller of the pressing member 210 to form the fusing nip. She support member 223 rotatably supports the belt member 221 having a pattern formed on the surface of the belt member 221.

In accordance with an exemplary embodiment of the present invention, the belt member 221 includes a heater, such as a CNT, provided at the surface of the belt member 221. Accordingly, the belt member 221 has characteristics of a surface heater. As a result, it may be unnecessary for the heating member 220 to be provided with a separate heat source because heat is emitted from the surface of the belt member 221. When the belt member 221 receives rotational force from the pressing roller, it travels along the outer surfaces of the fusing nip member 222 and support member 223 in a circulating manner while rotating in a state of contacting the pressing roller. The belt member 221 applies heat to the recording medium passing through the fusing nip defined between the belt member 221 and the pressing roller, thereby melting the toner transferred to the recording medium.

The pattern may be formed at an end of the belt member 221, and has a predetermined shape. For example, the pattern may be formed at an end of the belt member 221 in the form of a line having a length corresponding to ⅓ of the circumference of the belt member 221. Alternatively, the pattern may take the form of dots or other shapes spaced at regular intervals. The pattern may have portions colored with a particular color at regular intervals, to be distinguished from other portions of the pattern. The shape of the pattern is not limited to the illustrated examples as long as the pattern is able to be sensed, for example, by the pattern sensor 250.

The position of the pattern is not limited to a particular position on the surface of the heating member 220. When the pattern is formed at a position where the pattern does not contact the pressing member 210, the pattern sensor 250 may easily sense the pattern. When the pattern is formed at one of the metal members 228 joined to respective ends of the belt member 221, it may be possible to sense the pattern without damage of the pattern sensor 250 or sensing error of the pattern sensor 250 because the pattern is not heated.

The pattern sensor 250 senses the pattern formed at the surface of the belt member 221, and outputs the sensed result in the form of a signal. The controller 260 determines whether there is an error in the current rotation of the heating member 220, based on the output signal from the pattern sensor 250.

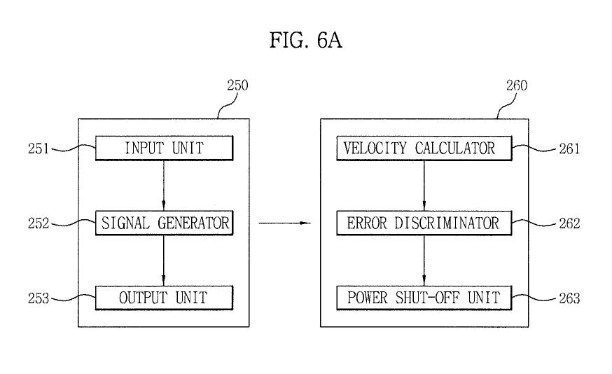

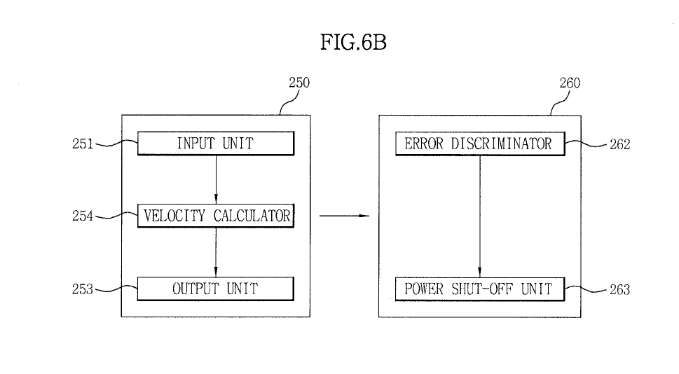

FIGS. 6A and 6B illustrate block diagrams of the pattern sensor 250 and controller 260.

As illustrated in FIG. 6A, in accordance with an exemplary embodiment of the present invention, the pattern sensor 250 outputs a signal representing whether a pattern has been sensed. When the pattern sensor 250 transmits the signal to the controller 260, a velocity calculator of the controller 260 calculates a linear velocity, based on the output signal. There is no limitation as to the kind of the pattern sensor 250 as long as the sensor used as the pattern sensor 250 senses a predetermined pattern, and outputs the sensed result in the form of a signal. For example, a reflection sensor or a photo sensor may be used as the pattern sensor 250.

The pattern sensor 250 includes an input unit 251 to receive a laser, infrared light, electric wave, image or the like transmitted from the pattern, a signal generator 252 to generate a signal representing a result of pattern sensing, and an output unit 253 to output the generated signal to the controller 260.

For example, when an infrared sensor, which is a reflection sensor, is used as the pattern sensor 250, infrared light reflected after being irradiated onto the pattern is input to the input unit 251, as an input signal. The signal generator 252 generates a signal representing the input signal, and outputs the generated signal to the controller 260 through the output unit 253.

In addition to the velocity calculator 261, which calculates a linear velocity of the pattern, the controller 260 includes an error discriminator 262 to discriminate whether there is an error in rotation of the heating member 220, and a power shut-off unit 263 to shut off power supplied to the heating member 220 when it is determined that there is an error.

Calculation of the linear pattern velocity in the velocity calculator 261 may be carried out using, for example, the time interval, at which elements of the pattern are sequentially sensed, the spacing of the elements of the pattern, or the periodic sensing time of a particular pattern, namely, the time taken for the particular pattern to be re-sensed after being sensed once.

When there is an error in rotation of the heating member 220 due to slippage generated in the fusing unit 200, the rotation velocity of the belt member 221 is reduced. In this case, the linear velocity of the pattern formed on the surface of the belt member 221 is reduced. Accordingly, the error discriminator 262 of the controller 260 may discriminate whether there is an error, based on the linear pattern velocity calculated by the velocity calculator 261.

The error discriminator 262 predetermines a pattern velocity range exhibited when the fusing unit 200 operates normally, for example, when the heating member 220 rotates normally. The error discriminator 262 discriminates whether the linear pattern velocity calculated by the velocity calculator 261 is within the predetermined pattern velocity range. For example, assuming that a linear pattern velocity of 255 m/s is exhibited when the fusing unit 200 normally operates, and a pattern velocity range greater than the linear pattern velocity by 30% or more is set to a normal pattern velocity range, the error discriminator 262 discriminates whether the linear pattern velocity received from the velocity calculator 261 is not less than 76.5 m/s. When the linear pattern velocity is not less than 76.5 m/s, the error discriminator 262 determines that there is no error. On the other hand, when the linear pattern velocity is less than 76.5 m/s, the error discriminator 262 determines that there is an error. The error discriminator 262 then outputs a signal representing the result of the discrimination.

When the error discriminator 262 outputs a signal representing that there is an error in the current rotation of the heating member 220, the power shut-off unit 263 shuts off power supplied to the belt member 221 in response to the signal from the error discriminator 262, thereby preventing danger such as fire caused by overheating.

Referring to FIG. 6B, in accordance with another exemplary embodiment of the present invention, the pattern sensor 250 directly detects the velocity of the pattern by sensing movement of the pattern. For example, a Doppler sensor, which is a velocity sensor using Doppler effects, may be used to detect the movement velocity of each element of the pattern. The Doppler sensor transmits the result of detection to the controller 260. There is no limitation as to the pattern sensor 250 as long as the sensor used as the pattern sensor 250 is able to detect the velocity of the pattern

The error discriminator 262 of the controller 260 receives the pattern velocity from the pattern sensor 250, and discriminates whether the pattern velocity is within the predetermined range, to determine whether there is an error, such as slippage, in the fusing unit 200. Based on the result of the determination, the error discriminator 262 outputs a signal representing error generation or normal operation. The output signal is transmitted to the power shut-off unit 263.

The power shut-off unit 263 shuts off power supplied to the belt member 221 when the error discriminator 262 outputs a signal representing error generation.

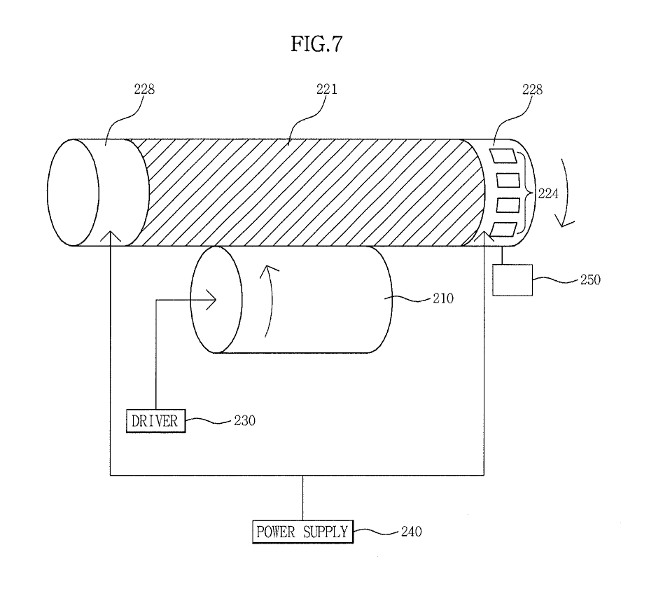

FIG. 7 illustrates a fusing unit 200 according to an exemplary embodiment of the present invention.

When a CNT belt is used as the belt member 221 of the heating member 220, the metal members 228 may joined to opposite ends of the belt member 221, respectively, for supply of power (see, for example, FIG. 4). In the embodiment of FIG. 7, the fusing unit 200 includes a pattern 224 formed on the surface of one metal member 228. In the illustrated embodiment, rectangular holes are formed at regular intervals in a circumferential direction of the CNT belt.

In order to sense the pattern 24 formed on the surface of the metal member 228, the pattern sensor 250 may be mounted beneath the pattern-formed metal member 228, as illustrated in FIG. 7. When power is supplied to the CNT belt, heat is uniformly emitted from the surface of the CNT belt. Although the pattern sensor 250 is mounted beneath the pattern-formed metal member 228, it may sense the pattern without influence of heat because the metal member 228 is not within a heat emission region. The mounting position of the pattern sensor 250 illustrated in FIG. 7 is only illustrative and, as such, there is no limitation as to the mounting position as long as it is possible to sense the pattern formed on the metal member 228 at the mounting position.

In the case in which the pattern sensor 250 of FIG. 7 only performs pattern sensing, as in the reflection sensor or photo sensor, the velocity calculator 261 receives an output from the pattern sensor 250, and calculates a linear velocity of the pattern, using the spacing of the rectangular holes and the sensing time interval of the rectangular holes, in accordance with the control configuration of FIG. 6A. For example, when the pattern sensor 250 senses 31 rectangular holes for one second under the condition that the rectangular holes are spaced at regular intervals of 3 mm, the velocity calculator 261 calculates 90 mm/s as the linear velocity of the pattern. The linear velocity of the pattern may be calculated using various methods.

The pattern sensor 250 senses the pattern in real time during operation of the fusing unit 200. The velocity calculator 261 periodically calculates the linear velocity of the pattern, based on the output from the pattern sensor 250. When the calculation period of the velocity calculator 261 is shortened, the accuracy of error discrimination is enhanced. The pattern sensing, velocity calculation, and error discrimination in the pattern sensor 250, velocity calculator 261 and error discriminator 262 are repeatedly executed during operation of the fusing unit 200.

The velocity calculator 261 transmits the velocity of 90 mm/s to the error discriminator 262 which, in turn, discriminates whether the velocity is within the normal velocity range. For example, when it is assumed that the normal pattern velocity range is not less than 76.5 mm/s, the error discriminator 262 determines that the fusing unit 200 currently operates in a normal state without an error. The error discriminator 262 then transmits the result of the discrimination to the power shut-off unit 263. In this case, the power shut-off unit 263 does not shut off power supplied to the CNT belt.

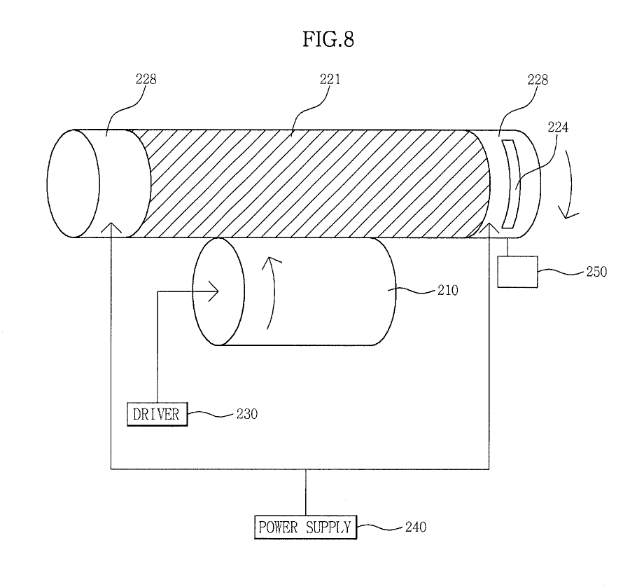

FIG. 8 illustrates an exemplary embodiment of a pattern.

Referring to FIG. 8, grooves aligned in the form of a line may be formed, as a pattern, on one of the metal members respectively joined at opposite ends of the CNT belt such that the pattern has a length corresponding to ⅓ of the circumference of the pattern-formed metal member. In a case in which a reflection sensor is mounted as the pattern sensor 250, the reflection sensor may continuously sense the line-shaped grooves when the CNT belt rotates in accordance with operation of the fusing unit 200. There is no groove sensed by the reflection sensor from the point of time when ⅓ of the circumference of the metal member passes the reflection sensor. Based on this information, the velocity calculator 261 may calculate the linear velocity of the pattern, and the error discriminator 262 discriminates whether the calculated pattern velocity is within the predetermined normal pattern velocity range.

Although an exemplary heating member 220 includes the belt member 221, which is a surface heater, the support member 223, and the fusing nip member 2222, the heating member 220 may include a roller-shaped core, and a heat emission layer, such as a CNT layer, formed on an outer circumferential surface of the core in an exemplary embodiment. The roller-shaped core is rotatable in a state of being in close contact with the pressing member 210, and a pattern may be formed at one end of the core, as in the above-described embodiments. When the core rotates, the linear velocity of the pattern may be calculated, and a generation of an error discriminated, based on the calculated linear pattern velocity. This exemplary embodiment has a similar configuration as the other exemplary embodiments, except that the heating member 220 includes the roller-shaped core, and the heat emission layer formed on the outer circumferential surface of the core.

An exemplary configuration and operation of the fusing unit according to an exemplary embodiment of the present invention is described.

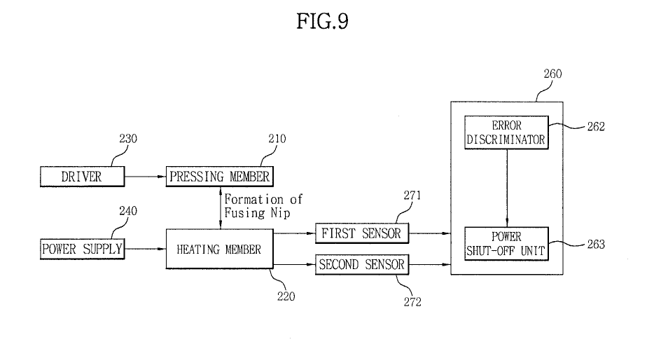

FIG. 9 illustrates a block diagram of a configuration of a fusing unit according to an exemplary embodiment of the present invention.

Referring to FIG. 9, the fusing unit according to an exemplary embodiment of the present invention includes a pressing member 210 to apply pressure to the recording medium at a fusing nip, a drive to drive the pressing member 210, a heating member 220 to apply heat to the recording medium while contacting the pressing member 210 at the fusing nip, and a controller 260 to determine whether there is an error in rotation of the heating member 220.

The pressing member 210, which includes a pressing roller and an elastic biasing unit, and the driver 230, which rotates the pressing member 210, are similar as those illustrated in FIG. 5 and, as such, no description thereof will be given.

The heating member 220 includes a belt member 221, which includes a surface heater such as a CNT belt, a fusing nip member 222 disposed at a region where the belt member 221 contacts the pressing roller of the pressing member 210, to form the fusing nip, and a support member 223 to rotatably support the belt member 221, which may have low rigidity.

The fusing unit includes a first sensor 271 to measure a temperature of the fusing nip at which the belt member 221 contacts the pressing member 210, and a second sensor 272 to measure a temperature of an outer surface of the belt member 221. The first sensor 271 may be mounted to the fusing nip member 222 within the belt member 221. The second sensor 272 may be mounted to the outside of the belt member 221. There are no limitation as to the kinds of the first and second sensors 271 and 272 other than a capability to measure temperature.

The controller 260 includes an error discriminator 262 to receive outputs from the first and second sensors 271 and 272, and to discriminate whether there is an error, based on the received outputs, and a power shut-off unit 263 to shut off power supplied to the belt member 221 when it is determined by the error discriminator 262 that there is an error.

The error discriminator 262 compares the temperature measured by the first sensor 271 with the temperature measured by the second sensor 272, and determines that there is an error, such as slippage, in the belt member 221 when the difference between the compared temperatures is not less than a predetermined reference value.

The exemplary embodiment illustrated in FIG. 9 is based on, for example, the fact that, when the belt member 221 does not normally rotate due to generation of slippage, the temperature increase rate at the fusing nip is greater than the temperature increase rate at the outer surface of the belt member 221 by a certain reference value or more.

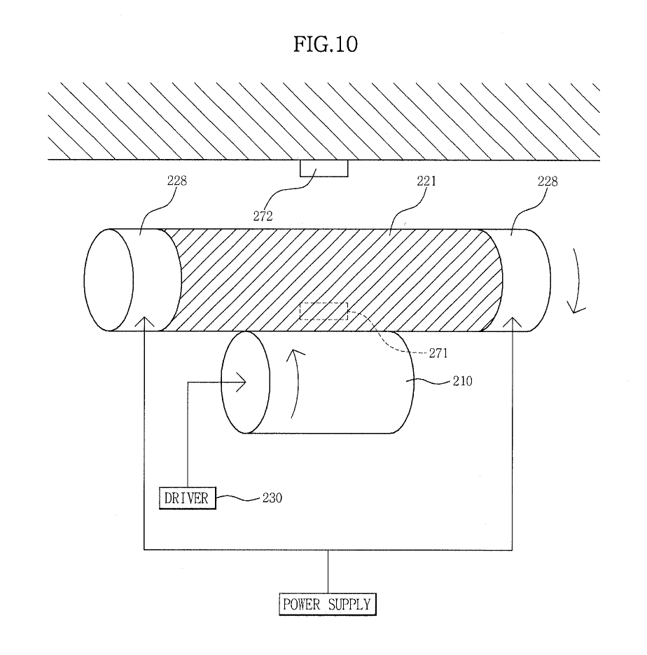

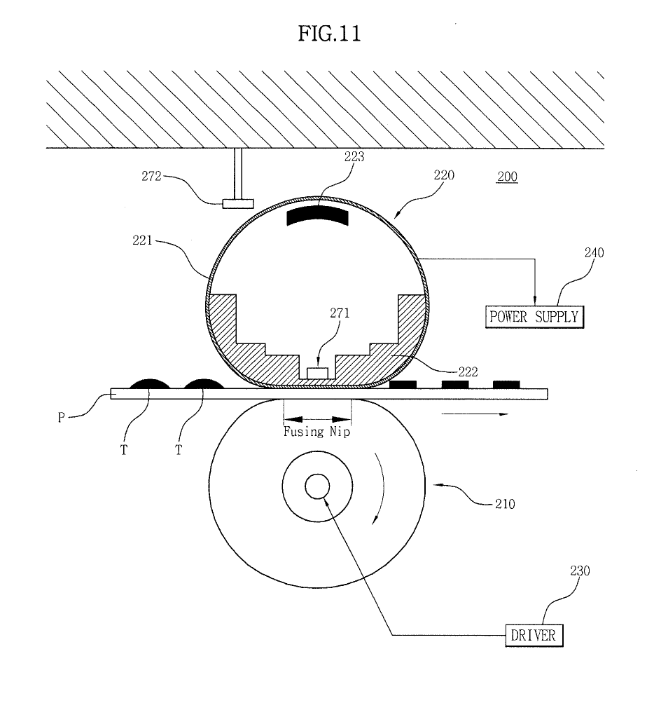

FIG. 10 illustrates a side view illustrating the fusing unit according to the embodiment of FIG. 9 when viewed toward outer circumferential surfaces of the pressing member 210 and heating member 220. FIG. 11 illustrates a sectional view illustrating the fusing unit according to the embodiment of FIG. 9 when viewed in a circumferential direction.

As illustrated in FIGS. 10 and 11, the first sensor 271 may be mounted to the fusing nip member 222 disposed within the belt member 221 to measure the temperature of the fusing nip. The second sensor 272 may be mounted at the outside of the belt member 221, to measure the surface temperature of the belt member 221. When the second sensor 272 is mounted at a position where the second sensor 272 does not face the support member 223 or fusing nip member 222 under the condition that the belt member 221 is interposed between the second sensor 272 and the support member 223 or fusing nip member 222, it is possible to measure the surface temperature of the belt member 221 under the condition that heat generated from the belt member 221 is absorbed by the support member 223 or fusing nip member 222.

A thermistor may be used as each of the first and second sensors 271 and 272. In accordance with an exemplary embodiment of the present invention, the thermistor may perform temperature measurement without being damaged by an internal heat source because the belt member 221 uses a surface heater, and there is no heat source within the belt member 221.

The belt member 221 may not rotate normally due to generation of slippage. In this case, the belt member 221, which has traveled along the outer surfaces of the fusing nip member 222 and support member 223 in a circulating manner, may be stopped. As a result, a portion A of the belt member 221 stays at the fusing nip. In this case, the belt member 221, which includes the surface heater, continuously emits heat unless power supplied to the belt member 221 is shut off. In this state, heat from the portion A of the belt member 221 may be absorbed by the fusing nip member 222 and support member 223 because the portion A of the belt member 221 is continuously in contact with the fusing nip member 222 and support member 223. From an outer surface portion of the belt member 221, which is not in contact with or adjacent to the fusing nip member 222 and support member 223, a relatively reduced amount of heat is absorbed by the fusing nip member 222 and support member 223. Since heat may be continuously generated in this state, the temperature of the outer surface of the belt member 221 is further increased, as compared to the temperature at the portion A.

As a result, the temperature measured by the first sensor 271 may be lower than the temperature measured by the second sensor 272. When the difference between the temperature measured by the first sensor 271 and the temperature measured by the second sensor 272 is not less than a predetermined reference value, the error discriminator 262 determines that there is an error such as slippage. When a thermistor is used as each of the first and second sensors 271 and 272, the error discriminator 262 converts outputs of the first and second sensors 271 and 272 into digital signals, using analog-digital convertor (ADC) ports, respectively, and estimates temperatures, based on the digital signals. Based on the estimated temperatures, the error discriminator 262 discriminates whether there is an error. When there is an error, the error discriminator 262 transmits a signal representing error generation to the power shut-off unit 263, to shut off power supplied to the belt member 221.

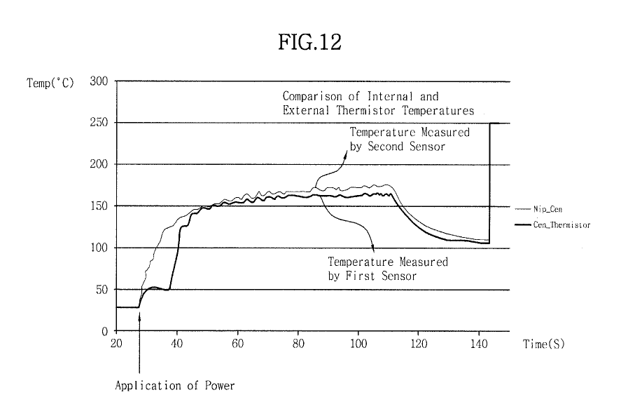

FIG. 12 illustrates a graph depicting variations in the temperatures measured when the fusing unit 200, for example, according to an exemplary embodiment of FIG. 9 operates normally. In this case, a thermistor may be used as each of the first and second sensors 271 and 272, and a CNT belt is used as the belt member 221.

When power is supplied to the CNT belt via the metal members 228 joined to opposite ends of the CNT belt, heat is generated in accordance with a resistance function of the CNT belt. As a result, the temperatures measured by the first and second sensors 271 and 272 are increased. In this state, heat from the portion A of the belt member 221 disposed beneath the fusing nip member 222, to which the first sensor 271 is mounted, may be absorbed by the fusing nip member 222 or pressing member 210. As a result, even when the belt member 221 operates normally, the temperature measured by the first sensor 271 may be more or less lower than the temperature measured by the second sensor 272.

However, when the belt member 221 rotates at normal speed, the belt member 221 repeatedly passes through the fusing nip such that successive portions thereof sequentially stay at the fusing nip for a short time, without that a particular portion of the belt member 221, for example, the portion A in FIG. 10, continuously stays at the fusing nip. Accordingly successive new heat sources are sequentially supplied to the fusing nip, and, the difference between the temperature measured by the first sensor 271 and the temperature measured by the second sensor 272 is not great. Referring to FIG. 12, illustrates a temperature difference is a maximum of 10° C. Based on this information, it may be possible to discriminate whether there is an error.

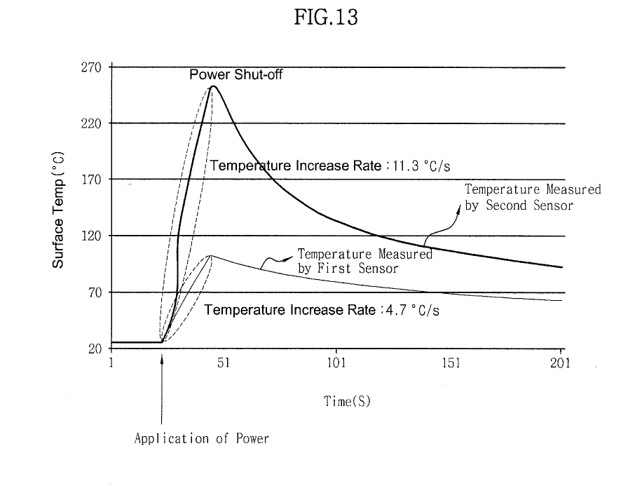

FIG. 13 illustrates exemplary variations in the temperatures measured when rotation of the belt member 221 is stopped due to slippage generated in the fusing unit 200, for example, according to the embodiment of FIG. 9.

Referring to FIG. 13, the temperature measured by the first sensor 271 and the temperature measured by the second sensor 272 are increased from the point of time when power is supplied to the CNT belt. Referring to temperature increase rates exhibited till the point of time when power is shut off, it may be seen that the temperature measured by the first sensor 271 exhibits an increase rate of 4.7° C./s, and the temperature measured by the second sensor 272 exhibits an increase rate of 11.3° C./s.

Thus, the error discriminator 262 predetermines a temperature difference corresponding to a condition that the belt member 221 does not normally operate, as a reference value. When the error discriminator 262 receives outputs from the first and second sensors 271 and 272 during operation of the fusing unit 200, it compares the difference between the outputs, namely, the difference between the temperatures measured by the two sensors 271 and 272, with the predetermined reference value. When the temperature difference is not less than the predetermined reference value, the error discriminator 262 determines that there is an error.

The predetermined reference value may be set, for example, by the designer or user through experiments. For example, in the case in which the reference value is set to 50° C., based on the results of FIGS. 12 and 13, it may be determined that there is an error when the difference between the temperature measured by the first sensor 271 and the temperature measured by the second sensor 272 is not less than 50° C. In this case, the error discriminator 262 transmits a signal representing error generation to the power shut-off unit 263.

Upon receiving the signal representing error generation, the power shut-off unit 263 immediately transmits a control signal to the power supply, to shut off power supplied to the CNT belt.

A control method for the image forming apparatus according to an exemplary embodiment of the present invention is described in detail.

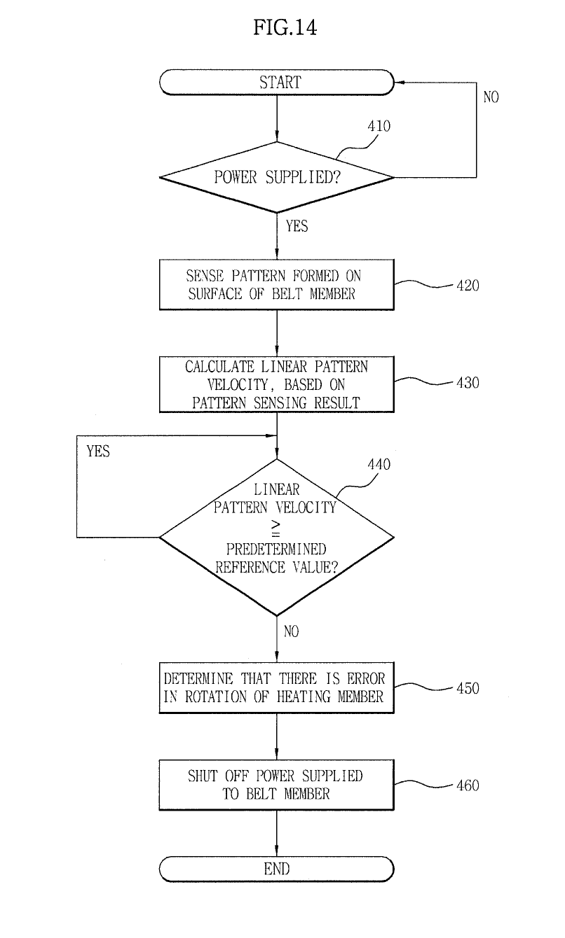

FIG. 14 illustrates a method of determining whether there is an error in the fusing unit of the image forming apparatus, for example, according to the embodiment of FIG. 5, and executing control, based on the result of the determination.

is The method determines whether a fusing process is begun in accordance with supply of power to the belt member 221 (operation 410). When the fusing process is begun (“YES” in operation 410), the pattern sensor 250 senses the pattern formed on the belt member 221 (operation 420). Since the pressing member 210 rotates in a state of being in close contact with the belt member 221, rotational force from the pressing member 210 is transmitted to the belt member 221. Accordingly, the belt member 221 rotates in a direction opposite to the rotation direction of the pressing member 210. As a result, the pattern formed on the surface of the belt member 221 is rotated. The pattern sensor 250 senses such movement of the pattern. When a sensor capable of only sensing whether there is a pattern, such as a reflection sensor or a photo sensor, is used as the pattern sensor 250, the sensor outputs the sensing result in the form of a signal. The output signal is transmitted to the velocity calculator 261.

The linear velocity of the pattern is calculated, based on the output value from the pattern sensor 250, namely, the pattern sensing result (operation 430). When a photo sensor, a reflection sensor or the like is used as the pattern sensor 250, calculation of the linear pattern velocity may be carried out using, for example, the time interval, at which elements of the pattern are sequentially sensed, the spacing of the elements of the pattern, or the periodic sensing time of a particular pattern, namely, the time taken for the particular pattern to be re-sensed after being once sensed. These methods are illustrative and, as such, the linear velocity of the pattern may be calculated using various methods. The calculated linear pattern velocity is transmitted to the error discriminator 262.

The error discriminator 262 discriminates whether the calculated linear pattern velocity is not less than a predetermined reference value (operation 440). The predetermined reference value may be a minimum linear pattern velocity exhibited when the belt member 221 rotates normally without generation of slippage.

When it is discriminated, based on the result of the discrimination, that the calculated linear pattern velocity is less than the predetermined reference value (“NO” in operation 440), it is determined that the belt member 221 does not normally rotate due to an error, such as slippage, generated in the belt member 221 (operation 450).

Thereafter, a signal representing error generation is generated, and is then transmitted to the power supply, to shut off power supplied to the opposite ends of the belt member 221 (operation 460).

On the other hand, when the calculated linear pattern velocity is not less than the predetermined reference value (“YES” in operation 440), it is determined that the belt member 221 rotates normally. In this case, the linear velocity of the pattern is newly calculated, and is then compared with the predetermined reference value.

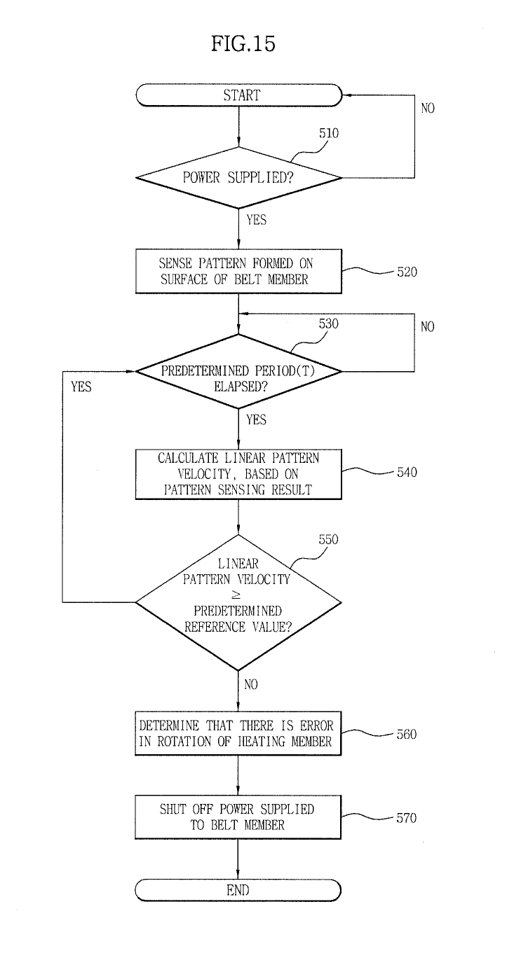

When a velocity sensor such as a Doppler sensor is used as the pattern sensor 250, it may be possible to calculate the linear velocity of the pattern, simultaneously with sensing of the pattern. However, when a reflection sensor, a photo sensor or the like is used as the pattern sensor 250, the linear velocity of the pattern is calculated at regular intervals. FIG. 15 shows a flowchart illustrating linear pattern velocity calculation in the latter case.

Referring to FIG. 15, when a fusing process is begun in accordance with supply of power to the belt member 221 (“YES” in operation 510), the pattern sensor 250 senses the pattern formed on the belt member 221, and then transmits an output thereof to the velocity calculator 261.

After a predetermined period T elapses (“YES” in 530), the velocity calculator 261 calculates the linear velocity of the pattern, based on the output from the pattern sensor 250 (540). For example, when it is assumed that the pattern formed on the surface of the belt member 221 includes rectangular holes and the predetermined period T is 3 seconds, it may be possible to calculate the linear velocity of the pattern, using the number of holes sensed by the pattern sensor 250 for 3 seconds, and the spacing of the holes.

When the calculated linear pattern velocity is less than the predetermined reference value (“NO” in operation 550), it is determined that there is an error in rotation of the heating member 220 (560). In this case, a signal representing error generation is generated, to shut off power supplied to the belt member 221 (operation 570).

On the other hand, when the calculated linear pattern velocity is not less than the predetermined reference value (“YES” in operation 550), it is determined that the heating member 220 rotates normally. Thereafter, a subsequent procedure is executed in accordance with whether the predetermined period T has elapsed.

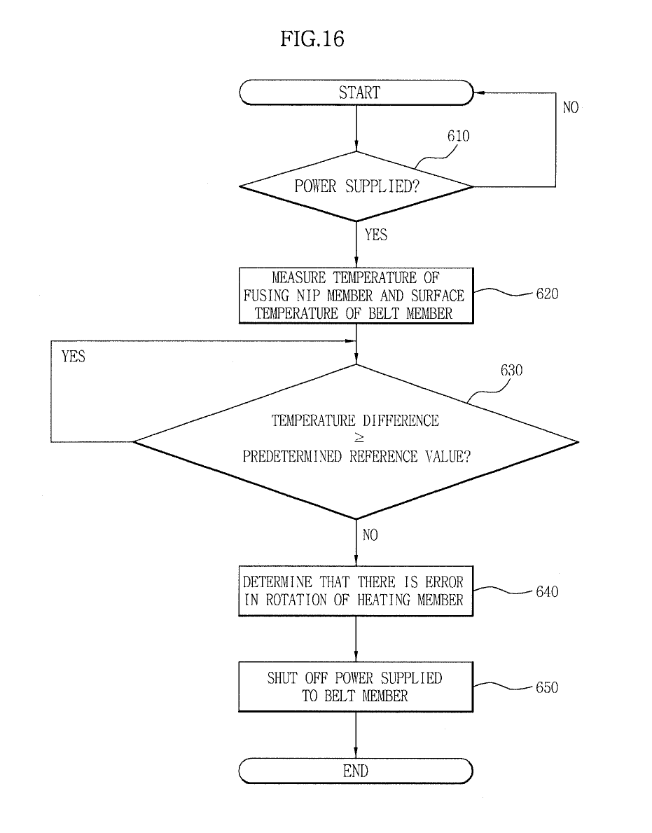

FIG. 16 illustrates a method of determining whether there is an error in the fusing unit of the image forming apparatus according to an exemplary embodiment of the present invention, and executing control, based on the result of the determination.

It is determined whether a fusing process is begun in accordance with supply of power from the power supply (operation 610). When the fusing process is begun (“YES” in 610), the temperature of the fusing nip member 222 disposed in the belt member 221 and the outer surface temperature of the belt member 221 are measured, using the first sensor 271 and second sensor 272 (operation 620).

The error discriminator 262 compares the temperatures measured by the first and second sensors 271 and 272. When the difference between the temperature measured by the first sensor 271 and the temperature measured by the second sensor 272 is not less than a predetermined reference value (“YES” in operation 630), the error discriminator 262 determines that the belt member 221 is stopped without rotation, i.e., there is an error (operation 640).

The error discriminator 262 generates a signal representing that there is an error in the fusing unit 220, and then transmits the signal to the power shut-off unit 263. In response to the signal, the power shut-off unit 263 may immediately shut off power supplied to the opposite ends of the belt member 221 (operation 650).

Temperature measurement of the first and second sensors 271 and 272 may be executed in real time. When the difference between the temperature measured by the first sensor 271 and the temperature measured by the second sensor 272 is less than the predetermined reference value (“NO” in operation 630), the error discriminator 262 determines that the belt member 221 operates normally. If the fusing process is in progress, the procedure of comparing the temperatures measured by the first and second sensors 271 and 272 may be repeatedly executed.

When the fusing process is executed in the image forming apparatus according to an exemplary embodiment of the present invention, it may be possible to accurately sense generation of an error such as slippage, even if a surface heater such as a CNT belt exhibiting low power consumption and excellent heating performance is applied to the heating member 220. Accordingly, it may be possible to prevent danger of a fire and degradation of printing quality caused by overheating.

According to an exemplary embodiment of the present invention, generation of a fire caused by overheating may be prevented and an enhancement in stability of an image forming apparatus achieved, regardless of the heating performance of a surface heater exhibiting used in a fusing unit of the image forming apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A fusing unit of an image forming apparatus capable of forming an image on a recording medium in an electrophotographic manner, comprising:
a heating member to heat the recording medium, the heating member being formed, at a surface thereof, with a predetermined pattern;
a power supply to supply power to the heating member;
a pressing member to transmit rotational force to the heating member while in contact with the heating member and to apply pressure to the recording medium;
a driver to rotatably drive the pressing member;
a pattern sensor to sense the pattern formed at the heating member and to output a result of the sensing in the form of a signal; and
a controller to determine whether there is an error in the rotation of the heating member, based on the output from the pattern sensor.

2. The fusing unit according to claim 1, wherein the heating member comprises:
a belt member comprising a surface heater;
a support member to rotatably support the belt member; and
a fusing nip member disposed at a region where the belt member receives pressure from the pressing member, to form a fusing nip.

3. The fusing unit according to claim 2, wherein the belt member comprises a carbon nanotube (CNT) belt.

4. The fusing unit according to claim 2, further comprising:
metal members respectively joined to opposite ends of the surface heater, to supply power to the surface heater,
wherein the pattern is formed at a surface of one of the metal members.

5. The fusing unit according to claim 1, wherein the pattern sensor comprises one selected from a group consisting of a reflection sensor, a photo sensor and a velocity sensor.

6. The fusing unit according to claim 1, wherein the controller comprises:
a velocity calculator to calculate a linear velocity of the pattern, based on the output from the pattern sensor; and
an error discriminator to discriminate that there is an error in the rotation of the heating member when the linear velocity of the pattern calculated by the velocity calculator is less than a predetermined reference value.

7. The fusing unit according to claim 6, wherein the controller further comprises:
a power shut-off unit to shut off power supplied from the power supply to the heating member when the error discriminator determines that there is an error.

8. A fusing unit of an image forming apparatus capable of forming an image on a recording medium in an electrophotographic manner, comprising:
a heating member comprising a surface heater to heat the recording medium;
a power supply to supply power to the heating member;
a pressing member to transmit rotational force to the heating member while in contact with the heating member and to apply pressure to the recording medium;
a driver to rotatably drive the pressing member;
a first sensor mounted in the heating member, to measure an internal temperature of the heating member;
a second sensor mounted to an outside of the heating member, to measure a surface temperature of the heating member; and
a controller to determine whether there is an error in the rotation of the heating member, based on outputs from the first and second sensors.

9. The fusing unit according to claim 8, wherein the controller comprises:
an error discriminator to discriminate that there is an error in the rotation of the heating member when a difference between the temperature measured by the first sensor and the temperature measured by the second sensor is not less than a predetermined reference value.

10. The fusing unit according to claim 9, wherein the controller further comprises:
a power shut-off unit to shut off power supplied from the power supply to the heating member when the error discriminator determines that there is an error.

11. The fusing unit according to claim 8, wherein the heating member comprises:
a belt member comprising the surface heater;
a support member to rotatably support the belt member; and
a fusing nip member disposed at a region where the belt member receives pressure from the pressing member, to form a fusing nip.

12. The fusing unit according to claim 11, wherein the first sensor is mounted to the fusing nip member, to measure a temperature of the fusing nip.

13. An image forming apparatus including a photosensitive body, an exposure unit to form an electrostatic latent image on the photosensitive body, a developing unit to develop the latent image, for formation of a toner image, a transfer unit to transfer the toner image formed by the developing unit to a recording medium, and a fusing unit to fuse the toner image transferred to the recording medium, wherein the fusing unit comprises:
a heating member to heat the recording medium, the heating member being formed, at a surface thereof, with a predetermined pattern;
a power supply to supply power to the heating member;
a pressing member to transmit rotational force to the heating member while in contact with the heating member and to apply pressure to the recording medium;
a driver to rotatably drive the pressing member;
a pattern sensor to sense the pattern formed at the heating member and to output a result of the sensing in the form of a signal; and
a controller to determine whether there is an error in the rotation of the heating member, based on the output from the pattern sensor.

14. The image forming apparatus according to claim 13, wherein the heating member comprises:
a belt member comprising a surface heater;
a support member to rotatably support the belt member; and
a fusing nip member disposed at a region where the belt member receives pressure from the pressing member while contacting the pressing member, to form a fusing nip.

15. The image forming apparatus according to claim 13, wherein the controller comprises:
a velocity calculator to calculate a linear velocity of the pattern, based on the output from the pattern sensor; and
an error discriminator to discriminate that there is an error in the rotation of the heating member when the linear velocity of the pattern calculated by the velocity calculator is less than a predetermined reference value.

16. The image forming apparatus according to claim 15, wherein the controller further comprises:
a power shut-off unit to shut off power supplied from the power supply to the heating member when the error discriminator determines that there is an error.

17. An image forming apparatus including a photosensitive body, an exposure unit to form an electrostatic latent image on the photosensitive body, a developing unit to develop the latent image, for formation of a toner image, a transfer unit to transfer the toner image formed by the developing unit to a recording medium, and a fusing unit to fuse the toner image transferred to the recording medium, wherein the fusing unit comprises:
a heating member to heat the recording medium while rotating;
a power supply to supply power to the heating member;
a pressing member to transmit rotational force to the heating member while in contact with the heating member and to apply pressure to the recording medium;
a driver to rotatably drive the pressing member;
a first sensor mounted in the heating member, to measure an internal temperature of the heating member;
a second sensor mounted to an outside of the heating member, to measure a surface temperature of the heating member; and
a controller to determine whether there is an error in the rotation of the heating member, based on outputs from the first and second sensors.

18. The image forming apparatus according to claim 17, wherein the controller comprises:
an error discriminator to discriminate that there is an error in the rotation of the heating member when a difference between the temperature measured by the first sensor and the temperature measured by the second sensor is not less than a predetermined reference value.

19. A control method for a fusing unit of an image forming apparatus to form an image on a recording medium in an electrophotographic manner, comprising:
sensing a pattern formed on a surface of a heating member to heat the recording medium;
calculating a linear velocity of the pattern based on a result of the sensing;
comparing the calculated linear velocity of the pattern with a predetermined reference value; and
determining that there is an error in a rotation of the heating member, when it is determined, based on a result of the comparison, the calculated linear velocity of the pattern is less than a predetermined value.

20. The control method according to claim 19, wherein the heating member comprises a belt member comprising a surface heater, a support member to rotatably support the belt member, and a fusing nip member disposed at a region where the belt member receives pressure from the pressing member, to form a fusing nip.

21. The control method according to claim 19, wherein metal members are joined to opposite ends of the surface heater, respectively, to supply power to the surface heater, and the pattern is formed at a surface of one of the metal members.

22. The control method according to claim 19, further comprising:
shutting off power supplied to the heating member when it is determined that there is an error in the rotation of the heating member.
